(19) United States
(12) Patent Application Publication
(10) Pub. No.: US 2002/0007419 A1
(43) Pub. Date: Jan. 17, 2002

(54) Internet service provider server system, method of providing data, method of advertising using moving pictures, and recording media therefor

(76) Inventors: Hoon Chang, Seoul (KR); Joon-Seok Woo, Seoul (KR); Seung-Hwan Lee, Seoul (KR); Kun-Tae Kim, Seoul (KR); Jong-Won Seo, Seoul (KR); Il-Taek Lim, Seoul (KR)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/887,547

(22) Filed: Jun. 22, 2001

(30) Foreign Application Priority Data
Jun. 23, 2000 (KR) 00-34809

(51) Int. Cl. G06F 15/16

(52) U.S. Cl. 709/232; 709/217

(57) ABSTRACT

The present invention relates to an ISP server, a method of providing data, a method of advertising using moving pictures, and recording media therefor. In a method of providing data from the ISP server to an internet user's computer system connected through the internet, the method of advertising according to the present invention comprises the steps of (a) receiving a data reception speed of an internet user's internet connection, (b) selecting a data frame set based on the received data reception speed, and (c) transmitting the selected data frame set to the internet user's computer system. According to this method, a moving picture can be provided more efficiently during the process of receiving a prescribed service through the ISP server.

### BACKGROUND OF THE INVENTION

1. Field of the Invention

The present invention relates to an internet service provider (ISP) server system, a method of providing data, a method of advertising using moving pictures, and recording media therefor, and more particularly, to an ISP server system, a method of providing data, a method of advertising using moving pictures, and a recording media therefor in order to provide data based on a reception speed of an internet user's internet connection.

2. Description of the Related Art

As the population of internet users rapidly increases, the connection to internet has become an important purpose of internet application. Thus, there are provided various methods of advertising using computer systems and ISP server systems.

Also, there are a variety of companies that provide a variety of services through the internet that are based on advertisement benefit from internet users. Examples of such internet service sites include search engine sites, electronic commerce sites, and information providing sites. In some cases, these sites display densely a variety of banner advertisements which are just one type of advertisement found on the internet.

Banner advertisements occupy a relatively small area of a display screen and, as the name implies, are shaped like banners. Thus, it is difficult to present content in banner advertisements that will attract potential customers. Furthermore, banner advertisements are so ubiquitous on the internet that sites without a single banner advertisement are seldom found. It is difficult to present internet users with a fresh impression using banner advertisements and this has resulted in the current situation of low banner advertisement clicking frequency.

To more effectively advertise on the internet, there have been provided advertisement methods that provide advertisements with various events which internet users can naturally participate in. The characteristics of these methods consist of procedures that internet users, who are the advertiser's target audience, can follow interactively, in contrast to one-way media such as TV and radio. However, the main purpose of visiting a web site is to use the service that the site provides, not to look at advertisements. Thus, it is common for internet users to leave a site right after the desired purpose is achieved without any interaction with an advertisement. For example, an internet user, who is interested in games, is more likely to visit a site that offers mainly games where he can enjoy a variety of games rather than play a game included in an advertisement.

Also, to increase the clicking frequency of a banner advertisement, animated GIFs are used in banner advertisements to give the impression of a moving graphical image. An animated GIF uses GIF89a type file containing a set of images in a specific order. An icon that rotates, a hand that waves, and a character that magically becomes bigger and bigger are all examples of animated GIFs. But, even though a banner advertisement is animated and attracts an internet user's attention, the internet user still has to click on the banner in order to communicate the intended message of linking to the advertiser's web site.

Since internet advertisements including banner advertisements can be interactive, unlike broadcasting media such as TV or radio, advertisers expected internet advertisements to be a more effective way of advertising. But contrary to the advertisers' expectation, interactive or two-way advertisements show to be less effective than one-way advertisements because internet users consider clicking on advertisements to be too bothersome.

### SUMMARY OF THE INVENTION

It is therefore an objective of the present invention to provide an ISP server system, a method of providing data, a method of advertising using moving pictures, and recording media therefor so that an internet user can be exposed more naturally and comfortably to advertisements while receiving a prescribed service through the ISP.

It is another objective of the present invention to provide an ISP server system, a method of providing data, a method of advertising using moving pictures, and recording media therefor that can normally provide a prescribed internet service and, at the same time, a moving picture advertisement of a relatively large file size.

In order to achieve the above objectives, there is provided a method of providing data between an internet user's computer system and an ISP server system that are connected through the internet, the method of providing data comprising the steps of (a) determining the data reception speed of an internet user's internet connection, (b) selecting subdata based on the determined data reception speed, and (c) transmitting the selected subdata to the internet user's computer system.

It is preferable that the data reception speed is determined by a speed sensing module which runs on the user's computer system and is transmitted from the ISP server to the user's computer.

Also, it is preferable that the selected subdata comprises a moving picture advertisement frame set.

Furthermore, there is provided a method of advertising using moving pictures which comprises the steps of (a) displaying a banner advertisement in a specific region of a display screen of an internet user's computer system, and (b) showing a moving picture advertisement, which is transmitted from an ISP server and stored on a storage part of the internet user's computer system, in a different region of the display screen in an interlocking manner with the banner advertisement.

The banner advertisement and the moving picture advertisement are preferably shown in respective regions of a web page transmitted from the ISP server.

Also, it is preferable that the moving picture advertisement is transmitted from the ISP server and that the ISP server selects one moving picture advertisement frame set corresponding to the data reception speed of the internet user's internet connection among a multitude of moving picture advertisement frame sets.

According to another aspect of the present invention, there is provided an ISP server system that is connected to an internet user's computer system via the internet, wherein the ISP server system comprises a server storage part where a multitude of subdata of different file sizes are stored, and a server part that receives a data reception speed of an internet user's internet connection, selects from a database subdata which is chosen in consideration of the data reception speed, and transmits the selected subdata to the user's computer system.

Preferably, the data reception speed is determined by a speed sensing module which runs on the internet user's computer system and is transmitted to the server part.

Also, it is preferable that the speed sensing module is transmitted from the ISP server to run on the internet user's computer system.

Furthermore, it is preferable that the subdata comprises a multitude of moving picture advertisement frame sets of different file sizes.

There is provided an ISP server that is connected to an internet user's computer system through internet, the ISP server comprising a speed sensing module that comprises a server storage part where a first client program is stored and runs on the internet user's computer system to which the first client's program is transmitted and that senses the data reception speed of the internet user's internet connection, and a data requesting module that provides the ISP server with the data reception speed determined by the speed sensing module and requests a prescribed data stored in the storage part of the user's computer system which receives the subdata corresponding to the data reception speed among a multitude of subdata that are selected in consideration of the prescribed data.

Preferably, the data requesting module receives a data list from the ISP server, requests the data that is not stored in the storage part of the user's computer system among data listed in the data list, and stops requesting data when the computer is communication with the outside.

It is also preferable that the first client program comprises a data deleting module that deletes data which is not listed in the data list from among the data stored in the storage part of the user's computer system.

The server storage part stores the second client program which displays the transmitted data and an interface web page for providing internet service. The second client program runs on the user's computer system as the interface web page is transmitted to the user's computer system, and is equipped with a calling module for calling the corresponding data from the storage part and a displaying module for displaying a moving picture called by the data calling module on a display unit of an internet user's computer system.

The ISP server may be a server for providing an internet telephone service which is a service that allows real-time two-way conversations via the internet. The data is a moving picture advertisement that is displayed in a prescribed region of the internet telephone service providing screen. The second client program requests a banner advertisement corresponding to a moving picture stored in the storage part of the user's computer system from the ISP server and then receives the banner advertisement. The displaying module, more preferably, displays the banner advertisement in an interlocking fashion with the moving picture advertisement.

Also, it is preferred that the displaying module displays the moving picture advertisement without sound when the internet telephone service is in use.

According to another aspect of the present invention, there is also provided a computer-readable recording medium on which a program is recorded. The program preferably comprises a data sensing module that determines a data reception speed of an internet user's internet connection and a data requesting module that provides an ISP server with the data reception speed and receives from the ISP server subdata corresponding to the data reception speed among a multitude of subdata of different file sizes.

Preferably, the data requesting module receives a data list from the ISP server, requests data that is not stored in the storage part of the internet user's computer system among the data listed in the data list, and stops requesting data when the computer system is in communication with the outside.

It is also preferable that the program further comprises a deleting module that deletes data stored in the storage part of the internet user's computer system but not found on the data list.

### BRIEF DESCRIPTION OF THE DRAWING(S)

The above objectives of the present invention will become more apparent by describing in detail a preferred embodiment thereof with reference to the attached drawing(s) in which:

FIG. 1 is a schematic view illustrating an internet telephone service internet telephone service provider (ITSP) system including an internet telephone service (ITS) server system 1 according to a preferred embodiment of the present invention;

FIG. 2 is a block diagram illustrating functions of the ITS server system 1 of FIG. 1;

FIG. 3 is a schematic view of a preferred embodiment of the ITS server system 1 of FIG. 2;

FIG. 4 is a diagram of any one of the computer systems 3a. . . 3n of FIG. 1.

FIG. 5 is a block diagram illustrating functions of the first client program according to a preferred embodiment of the present invention;

FIG. 6 is a block diagram illustrating functions of the second client program according to a preferred embodiment of the present invention;

FIG. 7 is a reference diagram illustrating constituents of a moving picture advertisement A stored in a moving picture database 23;

FIG. 8 is a lookup table for determining an appropriate moving picture advertisement frame set corresponding to the data reception speed of an internet user's internet connection, both of which are stored in the moving picture database 23;

FIG. 9 is an example of a moving picture advertisement list stored in the moving picture database 23;

FIG. 10 is a schematic diagram of an internet telephone service providing screen displayed on a display unit 42;

FIG. 11 is a flow chart illustrating procedures executed by the ITS server system 1 in a preferred embodiment of a method of advertising according to the present invention;

FIG. 12 is a flow chart explaining in detail the transmission procedure of the moving picture advertisement of FIG. 11;

FIG. 13 is a flow chart explaining a deletion procedure of the moving picture advertisement by the first client program 25 in a preferred embodiment of a method of advertising according to the present invention; and

FIG. 14 is a flow chart explaining procedures executed by a second client program in a preferred embodiment of a method of advertising according to the present invention.

### DESCRIPTION OF THE PREFERRED EMBODIMENTS

Preferred embodiments of the invention will be described in further detail hereinafter with reference to the accompanying figures.

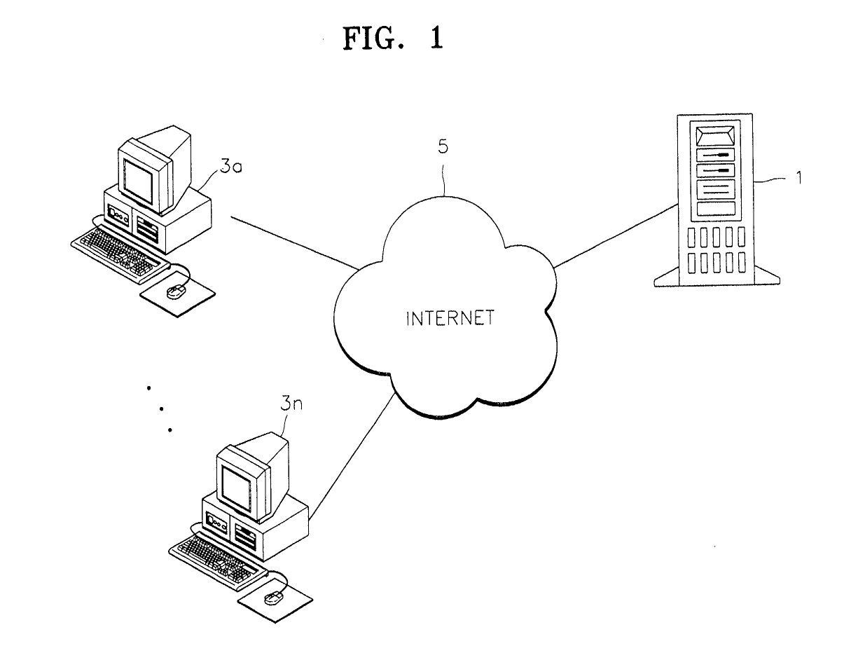

FIG. 1 is a schematic view of an ITSP system according to a preferred embodiment of the present invention. With reference to FIG. 1, the ITSP system comprises an ITS server system 1 and internet user's computer systems 3a. . . , 3n which are connected to the ITS server system 1 through the internet 5.

The ITS server system 1 provides an internet telephone service through the internet 5 and is a means for hosting the advertisements described in a method of advertising according to the present invention. The internet telephone service transmits voice signals through the internet 5, thus enabling long distance calls to be made via the internet 5. Internet long distance phone calls cost less than traditional long distance phone calls and as a result internet telephony has proved to be an attractive internet application.

The internet telephone service can be divided generally into two modes: computer-to-computer mode and computer-to-telephone mode. The computer-to-computer mode uses a method by which the ITS server system 1 takes a package of voice signals and transmits the package from one computer system to another computer system through the internet 5. The computer-to-telephone mode uses a method by which the ITS server system 1 takes a package of voice signals and transmits the package through the internet 5 from a computer system to a public switched telephone network (PSTN).

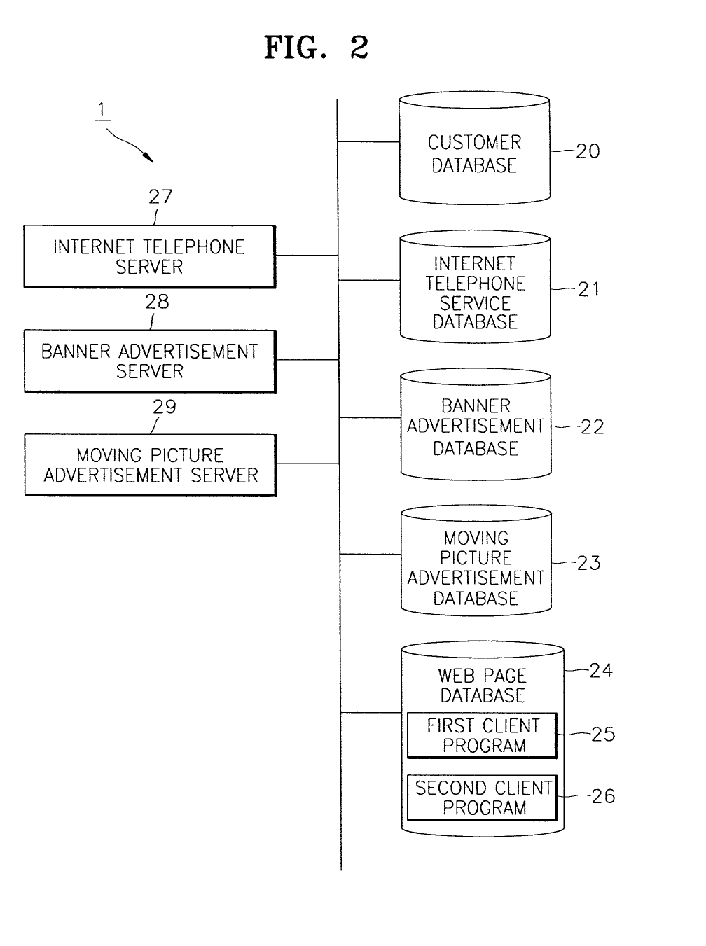

FIG. 2 is a block diagram illustrating functions of the ITS server system 1 (of FIG. 1). With reference to FIG. 2, the ITS server system 1 and comprises a customer database 20, an internet telephone service database 21, a banner advertisement database 22, a moving picture advertisement database 23, and a web page database 24 as a server storage part. The ITS server system 1 is preferably divided into separate servers: an ITSP server 27, a banner advertisement server 28, and a moving picture advertisement server 29.

The ITSP server 27, the banner advertisement server 28, and the moving picture advertisement server 29 may be coded separately as smaller, distinct programs or as one large program. The decision may be made in consideration of the hardware system or other application programs being used. The current trend is toward n-tier structured programs and so the ITSP server 27, banner advertisement server 28, and moving picture advertisement server 29 are preferably coded as individual programs.

The customer database 20 stores customer information such as customer ID under which a customer is registered as a member of the internet telephone service, a password, an e-mail address, a telephone number, an address, an itemized telephone information, and an address book containing a list of frequently used telephone numbers.

The internet telephone service database 21 stores data that is required to be provided to the ITSP server 27.

The banner advertisement database 22 stores a multitude of banner advertisements that are embodied as text or image files.

The moving picture advertisement database 23 store a multitude of moving picture advertisements that are the object data of the method of providing data according to the present invention. The moving picture advertisements are realized as real pictures having sound.

The web page database 24 stores a web page that will be transmitted to the internet user's computer systems 3a. . . 3n and a first client program 25. The web page comprises an interface web page for displaying the internet telephone service providing screen on the display units of the internet user's computer systems 3a. . . 3n in order to provide the internet telephone service. In the interface web page includes the second client program 26.

The second client program 26, which runs on the internet user's computer systems 3a. . . 3n, calls a moving picture advertisement and displays the called moving picture advertisement to be synchronized with a corresponding banner advertisement on the internet telephone service providing screen. In the present example, the second client program 26 is realized using a Java applet or JavaScript; however, it may be coded using other programming languages.

The first client program 25, which runs on the internet user's computer systems 3a. . . 3n, requests and receives a moving picture advertisement from the moving picture advertisement server 29. The first client program 25 may be made from various programming languages and is realized in the present example using an ActiveX control which is a kind of Dynamic Link Library (DLL). An ActiveX control can be created using any programming language that supports Microsoft's COM (Component Object Module), including commonly used Visual Basic and C⁺⁺.

The ITSP server 27 sends and receives the required data to and from the internet telephone service database 21. The ITSP server 27 takes a package of voice signals and transmits the package through the internet from one computer system to another computer system or to a PSTN after the packaged signal is passed through the internet 5 and reproduced as a voice signal.

The banner advertisement server 28 extracts from the banner advertisement database 22 a banner advertisement that is requested by the second client program 26, which runs on the internet user's computer systems 3a. . . 3n, and transmits the banner advertisement.

The moving picture advertisement server 29 receives the request from the first client program 25, which is loaded on and runs on the internet user's computer systems 3a. . . 3n, and transmits to each of the internet user's computer systems 3a. . . 3n a moving picture advertisement selected based on the data reception speed of the internet user's internet connection.

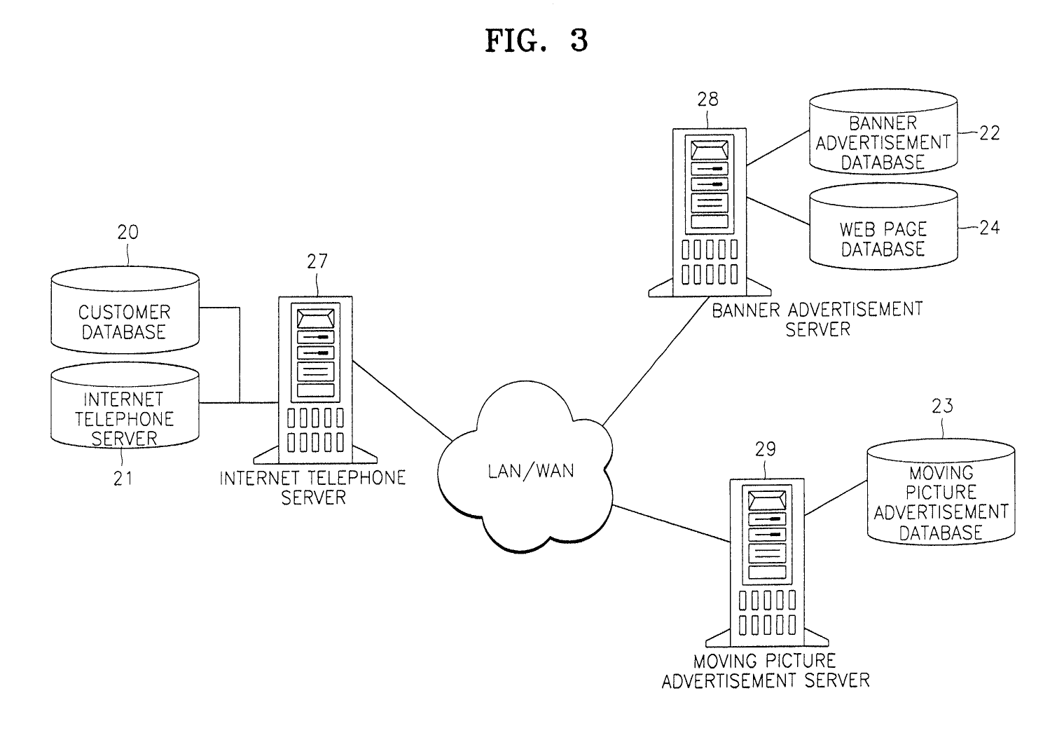

FIG. 3 is a preferred embodiment of the ITS server system 1 of FIG. 1. With reference to FIG. 3, the ITS server system 1 has a 3-tier structure where the ITSP server 27, the banner advertisement server 28, and the moving picture advertisement server 29 are separated and are connected through a local area network (LAN) or a wide area network (WAN).

FIG. 4 is a schematic diagram of the computer systems 3a. . . 3n of FIG. 1. With reference to FIG. 4, the computer systems 3a. . . 3n includes a hard disk and memory as a storage part, a computer main unit 43 equipped with a processor for executing the first and second client programs 25 and 26 in connection with the hard disk and memory, a display unit 42, a keyboard 48, and a mouse 46 containing a mouse button.

While the web page stored in the web page database 24 is transmitted to the computer systems 3a. . . 3n from the ITSP server 27 and is displayed on the display units 42, the first client program 25 realized as an ActiveX control is downloaded to the computer main units 43 separately from the web page, and the second client program 26 realized as an applet is downloaded to the computer main units 43 from the web page, and both are executed by the processor.

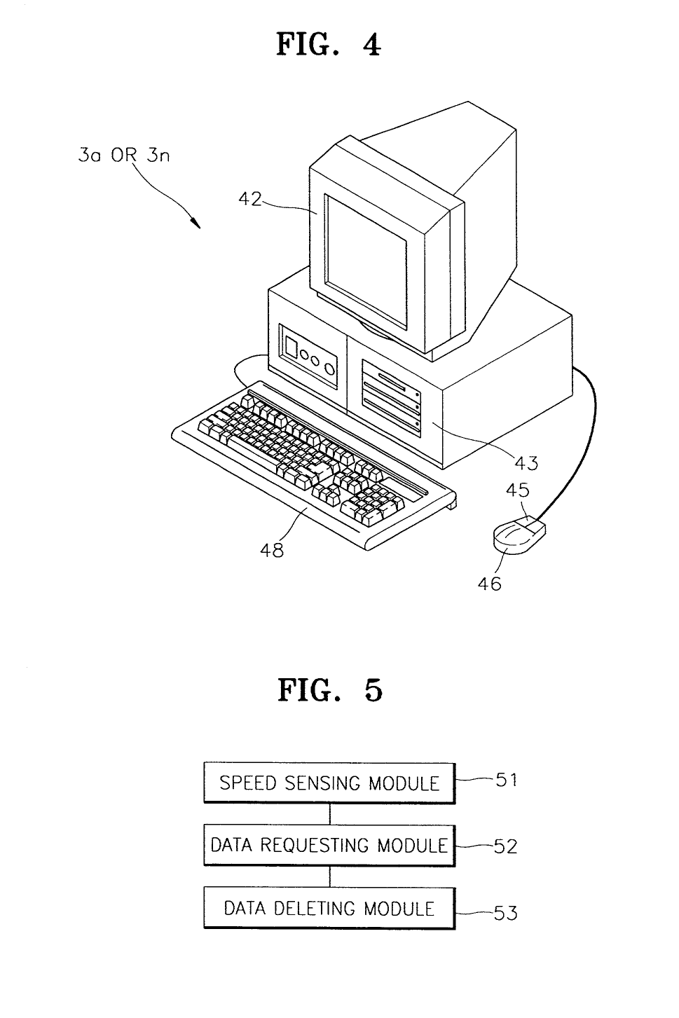

FIG. 5 is a block diagram illustrating functions of the first client program 25 according to a preferred embodiment of the present invention. With reference to FIG. 5, the first client program 25 comprises a speed sensing module 51, a data requesting module 52, and a data deleting module 53. The speed sensing module 51 determines the data reception speed at which each of the internet users' computer systems 3a. . . 3n receives data through the internet 5. The data requesting module 52 requests a moving picture advertisement from the moving picture advertisement server 29 and then receives and stores the moving picture advertisement on each of the computer systems 3a. . . 3n. The data deleting module 53 deletes the moving picture advertisement stored on each of the computer systems 3a. . . 3n, if necessary.

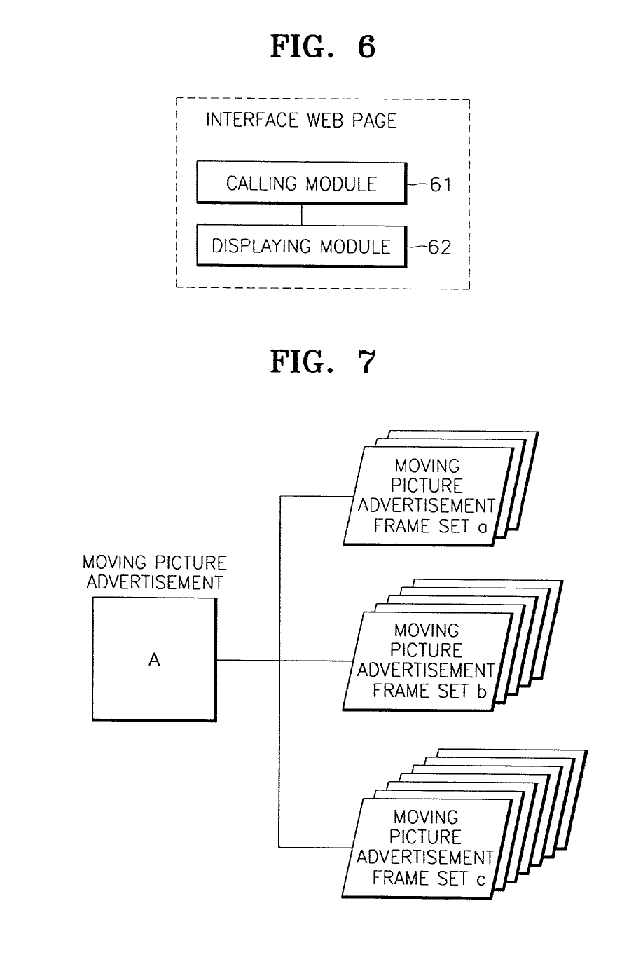

FIG. 6 is a block diagram illustrating functions of the second client program 26 according to a preferred embodiment of the present invention. With reference to FIG. 6, the second client program 26, which is included in the interface web page, comprises a calling module 61 and a displaying module 62. The calling module 61 calls the moving picture advertisement stored in the computer systems 3a. . . 3n and requests the banner advertisement server 28 to transmit the banner advertisement corresponding to the called moving picture advertisement and then receives the corresponding banner advertisement from the banner advertisement server 28. The displaying module 62 displays on the internet telephone service providing screen the moving picture advertisement called by the calling module 61 and the corresponding banner advertisement.

FIG. 7 is a reference diagram illustrating constituents of a moving picture advertisement A stored in the moving picture database 23. With reference to FIG. 7, a moving picture advertisement A has subdata which comprises moving picture frame sets a, b, and c. Each moving picture frame set is a real moving picture compressed by a standard compression algorithm, such as MPEG or H.261, and consists of a series of continuous bitmap images that are displayed at a rate of 60 frames per second. Frame set a is the smallest sized subdata file, and frame set c is the largest. The number of moving picture advertisement frame sets and the size of each subdata file may change as required.

The reason why a multitude of moving picture advertisement frame sets a, b, and c having the same content are prepared for one moving picture advertisement A is to transmit the appropriate moving picture advertisement frame set according to the data reception speed of internet user's internet connection.

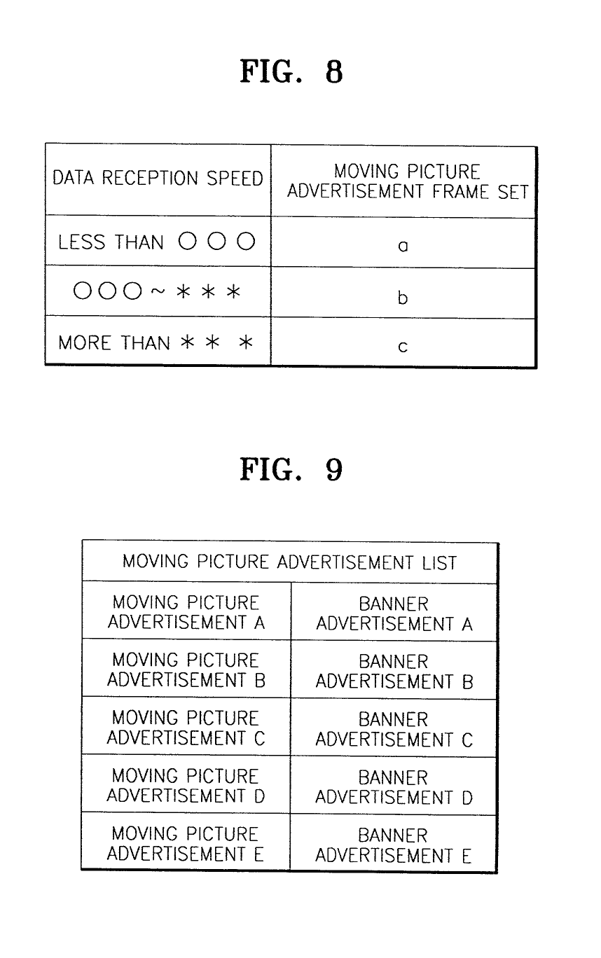

FIG. 8 is a lookup table for determining an appropriate moving picture advertisement frame set corresponding to the data reception speed of an internet users [symbol] internet connection, both of which are stored in the moving picture database 23. With reference to FIG. 8, if the internet user's computer system is connected to a low speed network, such as a PSTN, and the data reception speed is “less than ooo”, the smallest subdata file, moving picture frame set a, is transmitted. If the data reception speed is “ooo-***”, moving picture frame set b is transmitted. If the internet user's computer system is connected to a high speed network and the data reception speed is “more than ***”, moving picture frame set c is transmitted. As such, even if internet users are connected to a low speed network, an excessive amount of time is not spent downloading the moving picture advertisement.

FIG. 9 is an example of a moving picture advertisement list stored in the moving picture database 23. With reference to FIG. 9, each moving picture advertisement listed in the moving picture advertisement list has a corresponding banner advertisement. In other words, moving picture advertisement A corresponds to banner advertisement A. Similarly, moving picture advertisements B, C, D, and E correspond to banner advertisements B, C, D, and E, respectively. As will be described later, the moving picture advertisement list is transmitted to the first client program 25 from the moving picture advertisement server 29, and the first client program 25 consults with the moving picture advertisement list and requests the moving picture advertisement server 29 to send the moving picture advertisement that has not already been stored on the internet user's computer systems 3a. . . 3n.

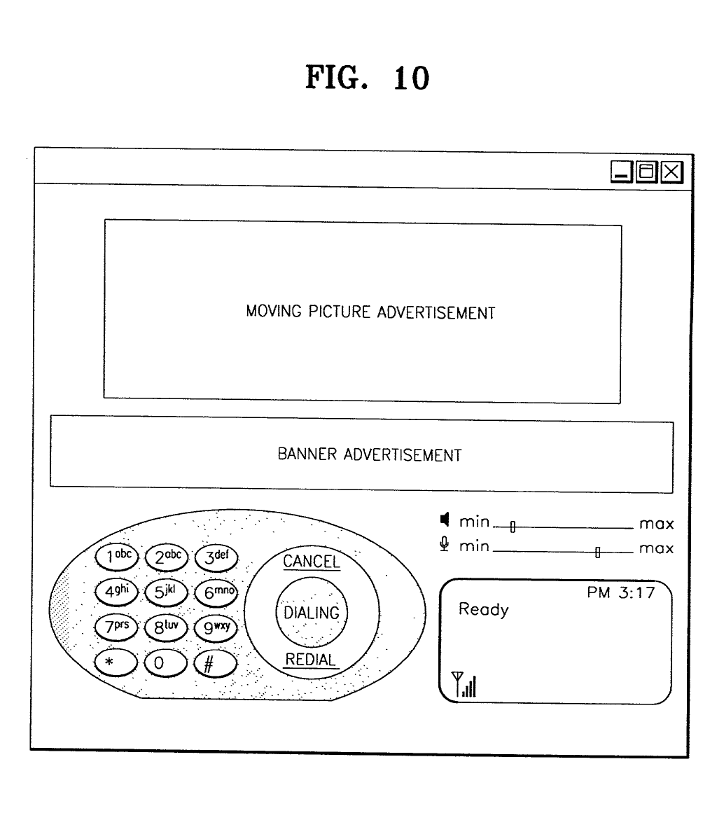

FIG. 10 a schematic diagram of an internet telephone service providing screen displayed on a display unit 42. With reference to FIG. 10, the interface for using the internet telephone service is presented on the internet telephone service providing screen. More particularly, the dial pad for clicking the receiver's telephone number is at the center and to the right of the dial pad is a status window showing the current status of the internet telephone connection. Above the dial pad are a banner advertisement window where the banner advertisement is displayed and a moving picture advertisement window where the moving picture advertisement is displayed.

A method of providing data and a method of advertising using moving picture advertisements according to the above-described preferred embodiment of the present invention are explained in the following.

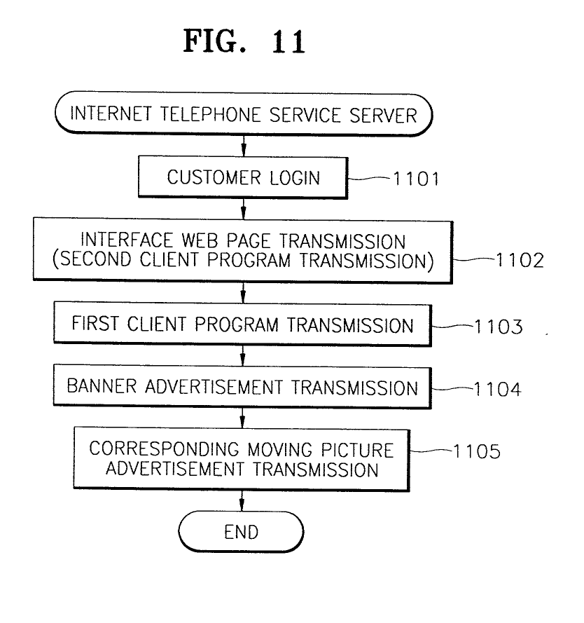

FIG. 11 is a flow chart illustrating the procedures executed by the ITSP server 27. As shown, an internet user connects to the home page of the ITS server system 1 through one of the computer systems 3a. . . 3n and inputs his ID and password in the log-in window shown on the home page and requests to log-in. In step 1101, the ITSP server 27 confirms the internet user's ID and password with the customer information stored in the customer database 20 and allows system log-in.

Subsequently, in step 1102, the ITSP server 27 extracts the interface web page for the internet telephone service providing screen from the web page database and sends the interface web page to the computer systems 3a. . . 3n. At the same time, the ITSP server 27 transmits the first client program 25 to the computer systems 3a. . . 3n in step 1103.

Next, the second client program 26 included in the interface web page and transmitted in step 1102 is executed by the processor of the internet user's computer main unit 43 and requests a banner advertisement from the banner advertisement server 28. In response to this request, the banner advertisement server 28 sends the banner advertisement in step 1104.

In addition, the second client program 26 is executed by the internet user's computer main unit 43 and requests a moving picture advertisement from the moving picture advertisement server 29. In response to this request, the moving picture advertisement server 29 sends the moving picture advertisement in step 1105.

According to this, the banner advertisement and the moving picture advertisement are both displayed on the internet telephone service providing screen of the internet user's display unit 42.

Below, the procedure by which the ITSP server 27 transmits the moving picture advertisement in step 1105 is explained in more detail.

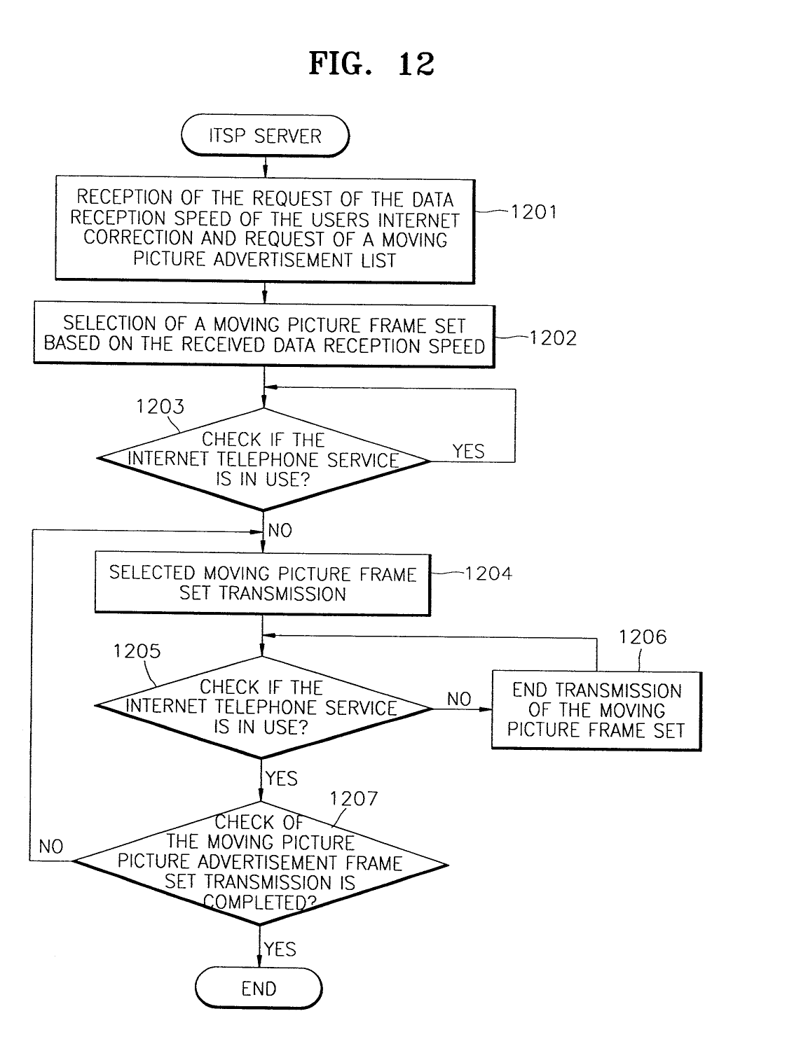

FIG. 12 is a flow chart explaining in detail the transmission procedure of the moving picture advertisement of FIG. 11 according to an embodiment of the method of providing data of the present invention. With reference to FIG. 12, while the speed sensing module 51 of the first client program 25 transmitted in step 1105 (of FIG. 11) determines the data reception speed of each of the internet users' computer systems 3a. . . 3n, the data requesting module 52 requests a moving picture advertisement list from the moving picture advertisement server 29. In response to the request, the moving picture advertisement server 29 transmits the moving picture advertisement list to the internet user's computer systems 3a. . . 3n in step 1201.

The data requesting module 52 confirms receipt of the moving picture advertisement list, and requests data not stored yet in the computer systems 3a. . . 3n, that is, the moving picture advertisement which is not downloaded from the moving picture advertisement server 29, and at the same time, provides the moving picture advertisement server 29 with the data reception speed determined by the data sensing module 51.

In step 1202, the moving picture advertisement server 29 selects an appropriate moving picture advertisement frame set which is determined using the lookup table from the moving picture advertisement database 23 based on the data reception speed.

The data requesting module 52 of the first client program 25 confirms whether or not the internet telephone service is in use in step 1204. If the internet telephone is not in use, the initiation of a download from the moving picture advertisement server 29 is requested. In response to this request, in step 1204, the moving picture advertisement server 29 sends the selected moving picture advertisement frame set to the internet user's computer systems 3a. . . 3n. The moving picture advertisement may be transferred via FTP (File Transfer Protocol) or HTTP (HyperText Transfer Protocol). If the internet telephone is in use, for example, an internet user is inputting a telephone number using the dial pad in order to use the internet telephone service or the customer is on the line with another party, step 1203 is repeated, that is, the data requesting module 52 again checks if the internet telephone service is in use.

During the transmission of the moving picture advertisement frame set, the internet phone service is checked to determine if it is in use in step 1205. If not in use, the ITSP server 27 checks if the moving picture advertisement frame set transmission is completed in step 1207. If the transmission is not completed, the ITSP server 27 repeats the procedures starting from step 1204.

If the internet telephone service starts or restarts, the data requesting module 52 stops requesting the moving picture advertisement from the moving picture advertisement server 29 in step 1206, and in response to this, the moving picture advertisement server 29 terminates the transmission of the moving picture advertisement frame set.

If the internet telephone service is terminated, the data requesting module 52 requests the download of the moving picture advertisement to restart. When all the requested moving picture advertisements have downloaded, the transmission from the moving picture advertisement server 29 is completed. When, if the moving picture advertisements listed in the moving picture advertisement list have been downloaded to the computer systems 3a. . . 3n, the data requesting module 52 does not perform any further downloads and ends the procedure.

Since the moving picture advertisement is displayed for a certain period of time as specified in a contract with an advertiser, the download of the moving picture advertisement is completed during the first few times an internet user connects to the ITSP server 27, and after these times, the moving picture stored in the computer systems 3a. . . 3n is displayed.

Below, the deletion procedure of the moving picture advertisement stored in the computer systems 3a . . . 3n by the first client program 25 is explained.

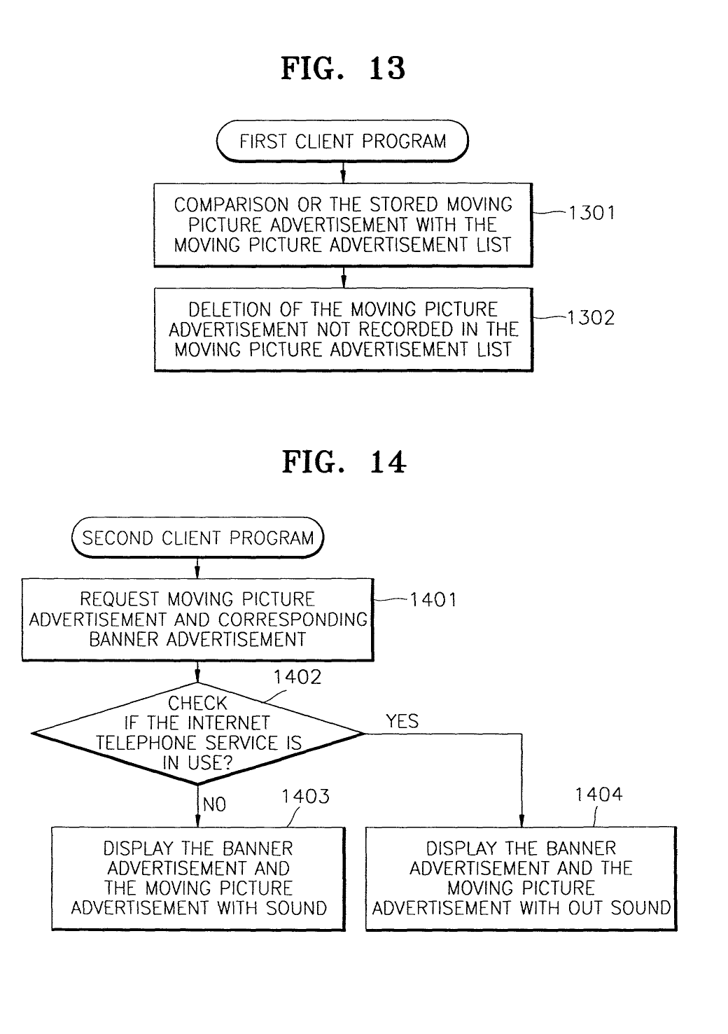

FIG. 13 is a flow chart that explains the deletion procedure of the moving picture advertisement by the deleting module 53 of the first client program 25. With reference to FIG. 13, the data deleting module 53 compares the moving picture advertisements in the moving picture advertisement list received from the moving picture advertisement server 29 with the moving picture advertisements stored in the computer main unit 43. If a stored moving picture advertisement is not listed in the moving picture advertisement list, it is deleted. That way, if the advertisement period is completed or a moving picture advertisement is replaced, the moving picture advertisement that will no longer be displayed is deleted, so as to minimize storage space usage of each of the internet user's computer systems 3a. . . 3n.

Below, the procedures executed by the second client program 26 is explained.

FIG. 14 is a flow chart that explains the procedures executed by the second client program. With reference to FIG. 14, the calling module 61 of the second client program 26 confirms receipt of the moving picture advertisement that has been completely downloaded by the first client program 25, and requests the banner advertisement server 28 for the banner advertisement corresponding to the downloaded moving picture advertisement in step 1401. In response to this request, the banner advertisement server 28 transmits the requested banner advertisement to the internet user's computer systems 3a. . . 3n.

The displaying module 62 ascertains whether the internet telephone service is in use in step 1402. If the internet telephone service is in use, the moving picture advertisement is displayed without sound in step 1403. If the internet telephone service is not in use, the moving picture advertisement is displayed with sound in step 1404. Here, even if the internet telephone is in use, the moving picture advertisement with sound is displayed in the case where the transmission and reception of voice signals are not in process. Only if the transmission and reception of voice signals are in process is the moving picture advertisement displayed without sound. As such, in the case where an internet user uses the internet telephone service, the interruption of service due to displaying of the moving picture advertisement is prevented by using a method that does not play sound.

The advertiser's URL is linked to the moving picture advertisement and the banner advertisement displayed, and when an internet user clicks on the moving picture advertisement or the banner advertisement, the linked URL is connected.

In the case where the internet telephone service is started before at least one moving picture advertisement frame set is completely downloaded, the advertisement displaying module 62 displays one of the moving picture frame sets that has already been completely transmitted or displays a separately prepared picture frame set. The separately prepared picture frame set may be transmitted together with the interface web page.

In the example explained above, the file size of the moving picture advertisement is considered so that the moving picture advertisement is downloaded via a file transfer method using the available free time of when the internet user is not using the internet telephone service. Alternatively, transmission of the moving picture advertisement may also be done by a streaming technique which entails sending the moving picture advertisement to the internet user's computer system after the moving picture advertisement is divided into small data packets. However, there is a restriction that in order to transmit a large size moving picture advertisement smoothly using the streaming technique, the internet connection speed should be supported. But, the internet is connected to and consists of a great deal of networks. Accordingly, since it can be seen as being more realistic that the speeds of the networks where the internet user's computer systems 3a. . . 3n is connected are distributed diversely, the multistep transmission method used in the example described above is more preferable.

Meanwhile, the first client program 25 in the example described above can be recorded in separate recording media and distributed independently on or off line. The recording media may be magnetic storage media (e.g., ROM, floppy disks, hard disks, etc.), optical reading media (e.g., CD-ROM, DVD, etc.), and carrier waves (transmission through communication network such as the internet).

Meanwhile, the above description refers to the data as moving picture advertisements; however, data is not necessarily limited to the moving picture advertisement, and the method of providing data may be applied to all data transmissions. In particular, in the case of the internet service providing multimedia files such as movies, large-sized multimedia files can be more smoothly transmitted using the method of providing data of the present invention.

As explained above, by controlling the size of data appropriately depending on the data reception speed of the internet user's computer system, according to the present invention, a prescribed internet service can be provided normally and, at the same time, a high quality, real photograph, moving picture advertisement of is provided. In other words, according to the present invention, by using free time appropriately during the process of receiving a prescribed service through the ISP server, the moving picture advertisement can be downloaded and displayed on an internet user's display unit.

What is claimed is:

1. A method of providing data for an internet service provider ISP server that is connected to an internet user's computer system through the internet, the method of providing data comprising the steps of:
(a) receiving the data reception speed of an internet user's internet connection;
(b) selecting subdata based on the received data reception speed; and
(c) transmitting the selected subdata to the internet user's computer system.

2. The method of providing data of claim 1, wherein the data reception speed is detected by a speed sensing module that runs on the internet user's computer system.

3. The method of providing data of claim 2, wherein the data sensing module is transmitted from the ISP server and runs on the internet user's computer system.

4. The method of providing data of claim 1, wherein the subdata comprises a multitude of moving picture advertisement frame sets of different file sizes.

5. A method of advertising using moving pictures comprising the steps of:
(a) displaying a banner advertisement in a prescribed region of a display unit of an internet user's computer system; and
(b) displaying a moving picture advertisement, which is transmitted from an ISP server and stored in a storage part of an internet user's computer system, in another region of the display unit and synchronized with the banner advertisement.

6. The moving picture advertisement method of claim 5, wherein the banner advertisement and the moving picture advertisement are shown in respective regions of the web page which is transmitted from the ISP server.

7. The moving picture advertisement method of claim 6, wherein the moving picture advertisement is transmitted from the ISP server and the ISP server extracts a moving picture advertisement frame set corresponding to the data reception speed of an internet user's internet connection among a multitude of moving picture advertisement frame sets and transmits it.

8. An ISP server system that is connected to an internet user's computer system through internet, the ISP server system comprising:
(a) a server storage part where a multitude of subdata of different file sizes are stored; and
(b) a server part that receives a data reception speed of an internet user's internet connection, extracts from a database a predetermined subdata which corresponds to the received data reception speed, and transmits the extracted subdata to an internet user's computer system.

9. The ISP server system of claim 8, wherein the data reception speed is sensed by a speed sensing module running on the internet user's computer system and transmitted to the server part.

10. The ISP server system of claim 9, wherein the subdata comprises a multitude of moving picture advertisement frame sets of different file sizes.

11. An ISP server system that is connected to an internet user's computer system through the internet, the ISP server system comprising:
(a) a speed sensing module that comprises a server storage part where a first client program is stored and that performs on the internet user's computer system to which the first client program is transmitted and that detects the data reception speed of an internet user's internet connection; and
(b) a data requesting module that provides an ISP server with the data reception speed detected by the speed sensing module and that requests a prescribed data stored in the storage part of the internet user's computer system which receives the subdata, wherein the subdata corresponds to the prescribed data and is selected in consideration of the data reception speed.

12. The ISP server system of claim 11, wherein the data requesting module receives a data list from the ISP server and requests the data that is not stored in the storage part of the internet user's computer system among the data listed in the data list.

13. The ISP server system of claim 12, wherein the data requesting module stops requesting data when the internet user's computer system is in communication with the outside.

14. The ISP server system of claim 13, wherein the first client program further comprises a data deleting module that deletes the data stored in the storage part of the internet user's computer system but not listed in the data list.

15. The ISP server system of claim 14, wherein the server storage part stores a second client program which displays the transmitted data and an interface web page for providing internet service, and wherein the second client program runs on the internet user's computer system as the interface web page is transmitted to the computer system, and is equipped with a calling module for calling the corresponding data from the server storage part and a displaying module for displaying the moving picture called by the data calling module on a display unit of an internet user's computer system.

16. The ISP server system of claim 15, wherein the ISP server is a server for providing an internet telephone service, the internet service is an internet telephone service, the data is a moving picture advertisement and is displayed at a prescribed region of an internet telephone service providing screen that is displayed on the display unit of an internet user's computer system, the second client program requests a banner advertisement corresponding to a moving picture stored in the storage part of the internet user's computer system from the ISP server and receives the banner advertisement, and the displaying module displays the banner advertisement to be synchronized with the moving picture advertisement.

17. The ISP server of claim 16, wherein the displaying module displays the moving picture advertisement without sound when the internet telephone service is in use.

18. A computer-readable recording medium that comprising:
(a) data sensing module for detecting a data reception speed of an internet user's internet connection; and
(b) a data requesting module that provides the ISP server with the data reception speed of an internet user's internet connection and that receives from the ISP server a selected subdata chosen in consideration of the data reception speed among a multitude of subdata of different file sizes.

19. The computer-readable recording medium of claim 18, wherein the data requesting module receives a data list from the ISP server, and requests the data that is not stored in the storage part of the internet user's computer system among the data listed in the data list.

20. The computer-readable recording medium of claim 19, wherein the data requesting module stops requesting data when the internet user's computer system is in communication with the outside.

21. The computer-readable recording medium of claim 20, further comprising a data deleting module that deletes data stored in the storage part of the internet user's computer system but not found on the data list.
